(19) United States
(12) Patent Application Publication
(10) Pub. No.: US 2004/0218220 A1
(43) Pub. Date: Nov. 4, 2004

(54) Enhanced error diffusion

(75) Inventors: Gerhard R. Thompson, Wappingers Falls, NY (US); Chai W. Wu, Poughquag, NY (US); Hong Li, Boulder, CO (US); Mikel J. Stanich, Longmont, CO (US)

Correspondence Address: IBM Corporation, Personal Systems Group, IP Law Dept. 9CCA/002-2, P.O. Box 12195, Research Triangle Park, NC, 27709-2195, US

(73) Assignee: International Business Machines Corporation, Armonk, NY

(21) Appl. No.: 10/426,076

(22) Filed: Apr. 29, 2003

(51) Int. Cl. H04N 1/40

(52) U.S. Cl. 358/3.03

(57) ABSTRACT

A method and system for performing enhanced error diffusion on a digital image is disclosed. The method and system include gathering statistics in a neighborhood of pixels around a current pixel to detect an amount of contrast in the neighborhood of pixels, and varying a threshold value in relation to the amount of detected contrast. According to the present invention, the amount of detected contrast is used to determine to what extent the neighborhood of pixels comprises an edge region or a non-edge region of the image in relation. Any distributed error assigned to the current pixel is added to the current pixel to obtain a new current pixel value. An output value for a pixel in the neighborhood of pixels is set based on whether the pixel value is less than, or greater or equal to, the threshold value. The method and system further include varying an amount of error distributed to the neighborhood of pixels in inverse relation to the amount of detected contrast, and repeating the above steps for each pixel in the image.

### FIELD OF THE INVENTION

The present invention relates to halftoning processes, more particularly to an improved error diffusion halftoning process.

### BACKGROUND OF THE INVENTION

Laser, inkjet, and most of other digital printers require some form of halftoning in order to print images. Halftoning is a well-known technique for converting a continuous tone image (e.g., a gray image), into a binary image (e.g., black and white) for printing or display by a binary device. For example, if a continuous tone digital image contains an array of pixels having values ranging between 0 and 1, then a binary image would contain an array of pixels having a value of either 0 or 1.

One type of halftoning, known as error diffusion, makes use of spatial averaging on a neighborhood of pixels. That is, during the error diffusion process, an error value computed from previously processed pixels is distributed, or added, to the value of the pixel currently being processed. The total value for that pixel is then compared with a predetermined fixed threshold value, and either a pixel value of 0 or 1 is output depending on whether the total value for the pixel is less than or greater or equal to the fixed threshold value.

FIG. 1 is a flow chart illustrating a conventional error diffusion halftoning process. The process assumes the existence of a digital continuous tone image where an array of pixel values may define text and image regions. The pixels of the image are processed in some order, such as in raster order, for instance, and the value V for the current pixel is retrieved in step 10. In step 12, a distributed error value (DE) calculated from a group of neighboring pixels is added to the value of the current pixel (V=V+DE).

In step 14, the total value V of the current pixel is compared to the prefixed threshold value T. If, for example, the pixel values in the input image range from 0 to 1, then T will have a value somewhere between 0 and 1. If the total value V of the current pixel is greater or equal to the threshold T, then in step 16, the corresponding output pixel is given a value of 1 and a new error is computed, which is V minus 1. If the total value V is less than the threshold T, then in step 18, the corresponding output pixel is given a value of 0, and the new error value is set equal to V.

Finally, in step 20, the new error E is distributed to pixels neighboring the current pixel, where the DE in step 12 is the sum of all distributions of E to the current pixel from other pixels. The process then continues until all pixels are processed.

This process preserves the gray value of a local region by distributing to neighboring pixels any gray value error associated with converting a single continuous tone pixel to a binary pixel. Since the error is not thrown away, but added to neighboring pixels and processed, the resulting average gray value, over some local neighborhood of the output, is roughly the same as the average gray value over the same neighborhood of the input. The disadvantage of this and other halftoning processes is that the sharp edges tend to become soft edges in the output image, and therefore halftoned images of text become somewhat blurred. The fixed value chosen for the threshold, T (0<=T<=1) has little effect on the resulting output image.

On the other hand, if no error is distributed to neighboring pixels, the conventional error diffusion process is reduced to a simple thresholding operation. In this case, the output image is very sensitive to the value chosen for the threshold. If the threshold is chosen to be some intermediate value between the dark text and light background values, then the text in the output image will appear sharp and black on a white background. However, if the threshold is chosen to be a darker value than the text, or a lighter value than the background, the text content of the original image will be completely lost in the output image.

One method for solving the problem of producing blurred text in the output image is to pre-segment the input image into text and non text regions, and then apply halftoning to only the non text regions. This solution, however, can be costly in terms of computation time and segmentation errors. An alternative solution is to halftone and print at very high resolutions so that even the halftoned text looks good. This solution however, requires expensive printing hardware.

Accordingly, what is needed is an improved error diffusion process that preserves the gray value of local regions in the input image, but that also retains sharpness in text and edge regions. The present invention addresses such a need.

### SUMMARY OF THE INVENTION

The present invention provides a method and system for performing enhanced error diffusion on a digital image. The method and system include gathering statistics in a neighborhood of pixels around a current pixel to detect an amount of contrast in the neighborhood of pixels, and varying a threshold value in relation to the amount of detected contrast. According to the present invention, the amount of detected contrast is used to determine to what extent the neighborhood of pixels comprises an edge region or a non-edge region of the image in relation. Any distributed error assigned to the current pixel is added to the current pixel to obtain a new current pixel value. An output value for a pixel in the neighborhood of pixels is set based on whether the pixel value is less than, or greater or equal to, the threshold value. The method and system further include varying an amount of error distributed to the neighborhood of pixels in inverse relation to the amount of detected contrast, and repeating the above steps for each pixel in the image.

According to the method and system disclosed herein, the present invention dynamically adjusts the threshold and distribution of error in such a way that sharp edges and text in the input image are preserved and enhanced, while uniform gray areas are halftoned. This is achieved by altering the enhanced error diffusion process applied, based on statistics of the neighborhood of pixels, anywhere from simple thresholding, at one end, to standard error diffusion at the other end. The more the neighborhood statistics reveal a high contrast region, the more the process approaches thresholding. The more the neighborhood statistics reveal a continuous tone image area, the more the process approaches standard error diffusion.

### BRIEF DESCRIPTION OF THE DRAWINGS

FIG. 1 is a flow chart illustrating a conventional error diffusion halftoning process.

FIG. 2 is a block diagram illustrating an enhanced error diffusion system in accordance with a preferred embodiment of the present invention.

FIG. 3 is a flow chart illustrating an enhanced error diffusion process in accordance with a preferred embodiment of the present invention.

FIG. 4 is a flow chart illustrating the enhanced error diffusion process in further detail.

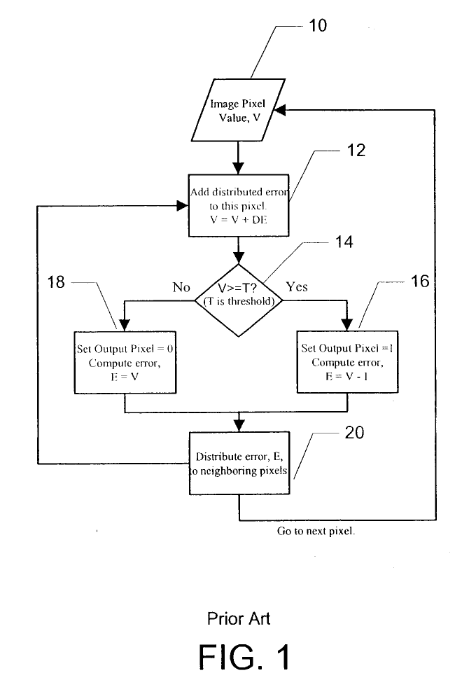

### DETAILED DESCRIPTION

The present invention relates to printing processes, more particularly to error diffusion halftoning. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown but is to be accorded the widest scope consistent with the principles and features described herein.

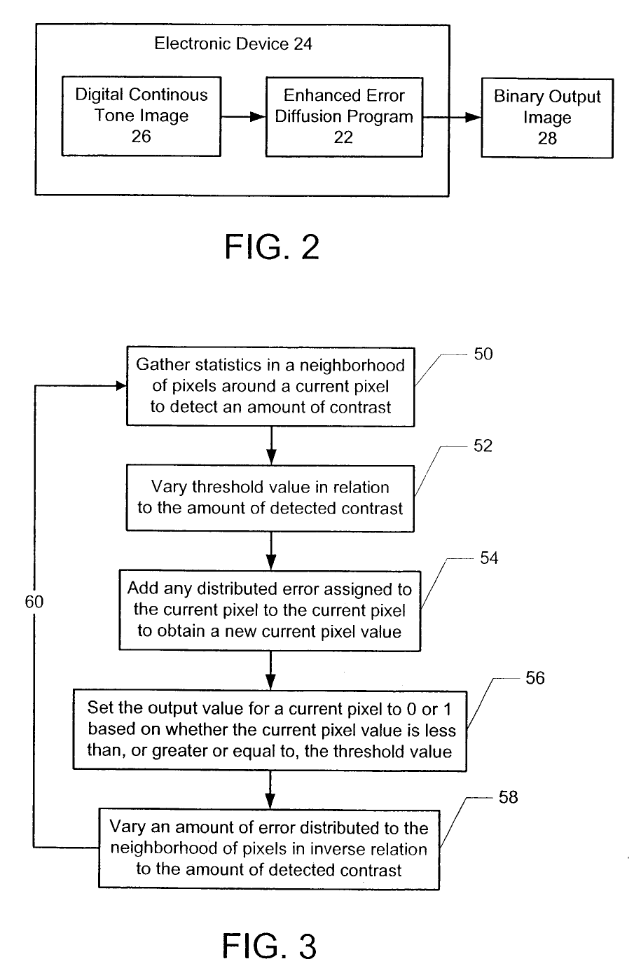

FIG. 2 is a block diagram illustrating an enhanced error diffusion system in accordance with a preferred embodiment of the present invention. The system 21 includes an enhanced error diffusion program 22 that is executed in an electronic device 24 for converting a digital continuous tone image 26 into a binary output image 28 for printing or display. Examples of electronic device 24 may include a computer, printer, scanner, copier, facsimile, and camera, for instance. The enhanced error diffusion program 22 may be stored on any computer-readable medium, such as internal non-volatile memory, disk, or networked storage device. Alternatively, the enhanced error diffusion program 22 may be implemented as hardware, rather than software.

According to the present invention, the enhanced error diffusion program 22 implements a modified error diffusion halftoning algorithm in which areas of the input image 26 having high contrast are processed differently than areas with low contrast to preserve sharp text and edges in the output image 28. More specifically, the enhanced error diffusion program 22 combines dynamic thresholding with normal error diffusion. Dynamic thresholding is performed primarily on edge regions of the image to output sharp edges, while normal error diffusion is performed primarily on smooth or non-edge regions to preserve gray levels, keeping in mind that transitions between edge and non-edge regions are gradual.

FIG. 3 is a flow chart illustrating an enhanced error diffusion process in accordance with a preferred embodiment of the present invention. The process begins in step 50 by gathering statistics in a neighborhood of pixels around a current pixel to detect an amount of contrast in the neighborhood of pixels. According to the present invention, the amount of contrast is used to determine the extent to which the neighborhood of pixels comprises an edge region or a non-edge region of the input image. In step 52, a threshold value is varied in relation to the amount of detected contrast or contrast related statistics. In step 54, any distributed error assigned to the current pixel is added to the current pixel to obtain a new current pixel value. In step 56, the output value for a current pixel is set to 0 or 1 based on whether the current pixel value is less than or greater or equal to the threshold value. In step 58, an amount of error distributed to the neighborhood of pixels is varied in inverse relation to the amount of detected contrast. That is, the more contrast is detected in the neighborhood, the less error is distributed, thereby maintaining sharp edges. The above steps are performed on each pixel in the image 26 via loop 60.

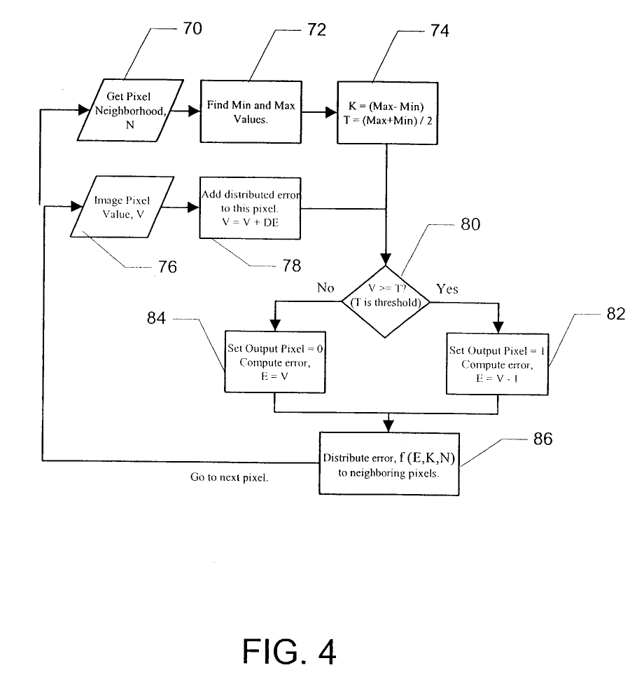

FIG. 4 is a flow chart illustrating a preferred embodiment of the enhanced error diffusion process in further detail. In step 70, the pixel values in a pixel neighborhood, N, of a current pixel are retrieved. In step 72, representations of the minimum and maximum pixel values in the neighborhood are found. In step 74, the amount of contrast, K, in the neighborhood is determined by calculating the spread or difference between the representations of the maximum (max) and minimum (min) pixel values, K=Max−Min, and the threshold, T, may then be determined by T=(Max+Min)/2.

In steps 76 and 78, the value V for the current pixel is retrieved and then added with a distributed error value (V=V+DE). In step 80, the total value V of the current pixel is compared to a prefixed threshold value T. If the total value V of the current pixel is greater or equal to the threshold T, then in step 82 a corresponding output pixel is given a value of 1, and a new error is computed, which is V minus 1. If the total value V is less than the threshold T, then in step 84, the corresponding output pixel is given a value of 0, and the new error value is set equal to V.

In step 86, the error is calculated as a function of the previous calculated error, the detected contrast, and the pixel neighborhood, f(E,K,N), and the error is distributed to the neighboring pixels. According to the present invention, the function f(E,K,N) varies the amount of error that is distributed during the error diffusion process. In order to enhance text and edges, this function diminishes the distributed error as the contrast in the neighborhood of the current pixel increases. In other words, as f(E,K,N) approaches 0, the enhanced error diffusion process becomes simple thresholding. As f(E,K,N) approaches the error E, the enhanced error diffusion process becomes normal error diffusion. An example of f(E,K,N) is E*(1−(Max−Min))/1 where K=Max−Min and Max and Min are representative of the maximum and minimum pixel values, respectively, in the pixel neighborhood N. In this example as Max−Min approaches 1, indicating a high contrast region, f(E,K,N) approaches 0. As Max−Min approaches 0, indicating a constant gray neighborhood, f(E,K,N) approaches E. Other measures of contrast may also be used.

According to the present invention, the statistics gathered to analyze the contrast for the pixel neighborhoods are min and max values. However, these values are used by the program 22 in different ways. The contrast may be measured by max-min, while the threshold value may be calculated by (min+max)/2, for example. So the same values used for detecting contrast are used to compute the threshold value. Also, instead of using absolute max and min values, the values defining the top 10 percentile or bottom 10 percentile respectively could also be used, etc. Alternatively, one could actually compute gradients for the contrast, which would involve the difference in value between pixels divided by the difference in spacing, and so on.

An enhanced error diffusion process has been described. The enhanced error diffusion process outputs sharp edges using dynamic thresholding, while maintaining desired gray levels in smooth regions using normal error diffusion. The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

What is claimed is:

1. A method for performing error diffusion on a digital image comprising an array of pixel values, the method comprising the steps of:
(a) gathering statistics in a neighborhood of pixels around a current pixel to determine an amount of contrast in the neighborhood of pixels of the image;
(b) varying a threshold value in relation to the amount of detected contrast;
(c) adding any distributed error assigned to the current pixel to obtain a new current pixel value;
(d) setting an output value for a pixel in the neighborhood of pixels based on whether the pixel value is less than, or greater or equal to, the threshold value;
(e) varying an amount of error distributed to the neighborhood of pixels in inverse relation to the amount of detected contrast; and
(f) performing steps (a) through (e) for each pixel in the image.

2. The method of claim 1 wherein the statistics gathered are used to both detect the amount of contrast as well as to calculate the threshold value.

3. The method of claim 2 wherein step (a) further includes the step of: detecting an amount of contrast, K, by finding representations of maximum (Max) and minimum (Min) pixel values in the neighborhood and calculating a difference between the maximum and the minimum.

4. The method of claim 3 wherein step (b) further includes the step of: determining the threshold value, T, as T=(Max+Min)/2.

5. The method of claim 4 wherein step (d) further includes the step of: varying the amount of error distributed to the neighborhood of pixels using a function f(E,K,N) that diminishes the error as contrast in the neighborhood of pixels of the current pixel increases.

6. A computer-readable medium containing program instructions for performing error diffusion on a digital image comprising an array of pixel values, the program instructions for:
(a) gathering statistics in a neighborhood of pixels around a current pixel to determine an amount of contrast in the neighborhood of pixels of the image;
(b) varying a threshold value in relation to the amount of detected contrast;
(c) adding any distributed error assigned to the current pixel to obtain a new current pixel value;
(d) setting an output value for a pixel in the neighborhood of pixels based on whether the pixel value is less than, or greater or equal to, the threshold value;
(e) varying an amount of error distributed to the neighborhood of pixels in inverse relation to the amount of detected contrast; and
(f) performing steps (a) through (e) for each pixel in the image.

7. The computer-readable medium of claim 6 wherein the statistics gathered are used to both detect the amount of contrast as well as to calculate the threshold value.

8. The computer-readable medium of claim 7 wherein instruction (a) further includes the instruction of: detecting an amount of contrast, K, by finding representations of minimum and maximum pixel values in the neighborhood and calculating a difference between the maximum and the minimum.

9. The computer-readable medium of claim 8 wherein instruction (b) further includes the instruction of: determining the threshold value, T, as T=(Max+Min)/2.

10. The computer-readable medium of claim 9 wherein instruction (d) further includes the instruction of: varying the amount of error distributed to the neighborhood of pixels using a function f(E,K,N) that diminishes the error as the contrast in the neighborhood of pixels of the current pixel increases.
